(19) United States
(12) Patent Application Publication
(10) Pub. No.: US 2026/0023389 A1
(43) Pub. Date: Jan. 22, 2026

(54) PREDICTING OBJECT MOTION IN A MULTIDIMENSIONAL ENVIRONMENT USING MACHINE LEARNING MODELS

(71) Applicant: QUALCOMM Incorporated, San Diego, CA (US)

(72) Inventors: Soenke BEHRENDS, Amsterdam (NL); Pim DE HAAN, Amsterdam (NL); Johann Hinrich BREHMER, Amsterdam (NL)

(21) Appl. No.: 18/954,025

(22) Filed: Nov. 20, 2024

Related U.S. Application Data
(60) Provisional application No. 63/673,418, filed on Jul. 19, 2024.

(51) Int. Cl. G05D 1/633; B25J 9/16; G05D 101/15; G06N 3/0455

(52) U.S. Cl. CPC G05D 1/633; G06N 3/0455; B25J 9/1674; G05D 2101/15

(57) ABSTRACT

Certain aspects of the present disclosure provide techniques and apparatus for accurately predicting the movement and location of objects in a multidimensional space. An example method generally includes receiving an input defining a location of an object in a three-dimensional space at a first time. The input generally includes a plurality of tokens. Using a transformer neural network, a predicted movement for tokens in the plurality of tokens is generated. Generally, the predicted movement includes a translation and a rotation associated with individual tokens in the plurality of tokens. The predicted movement is translated into an object-wise predicted movement. Based on the object-wise predicted movement and the location of the object in the three-dimensional space, a predicted location of the object at a second time subsequent to the first time is output.

### CROSS-REFERENCE TO RELATED APPLICATION(S)

This application claims the benefit of and priority to U.S. Provisional Application No. 63/673,418, filed Jul. 19, 2024, which is assigned to the assignee hereof and hereby expressly incorporated by reference in its entirety as if fully set forth below and for all applicable purposes.

### INTRODUCTION

Aspects of the present disclosure relate to machine learning models.

Machine learning models can be used to perform various tasks, such as tasks based on computer vision, natural language processing, audio processing, and the like. Single-purpose models may be trained to perform a specific task. For example, in an autonomous driving scenario, different models may be trained to perform semantic segmentation (e.g., to divide visual content into different regions corresponding to different types of objects), object detection, motion prediction, and the like. In some examples, in a robotics environment, various machine learning models can be used to identify objects in a three-dimensional space, manipulate and move objects within the three-dimensional space, and perform other actions related to a robotic manipulator (e.g., a robotic arm) or the objects in the three-dimensional space.

### BRIEF SUMMARY

Certain aspects generally relate to accurately predicting object motion using machine learning models.

Certain aspects provide a processor-implemented method for predicting object motion using a machine learning model. An example method generally includes receiving an input defining a location of an object in a three-dimensional space at a first time. The input generally includes a plurality of tokens. Using a transformer neural network, a predicted movement for tokens in the plurality of tokens is generated. Generally, the predicted movement includes a translation and a rotation associated with individual tokens in the plurality of tokens. The predicted movement is translated into an object-wise predicted movement. Based on the object-wise predicted movement and the location of the object in the three-dimensional space, a predicted location of the object at a second time subsequent to the first time is output.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and apparatus comprising means for performing the aforementioned methods as well as those further described herein.

The following description and the related drawings set forth in detail certain illustrative features of one or more aspects.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 depicts an example pipeline for predicting future locations of objects in a multidimensional space using a machine learning model, in accordance with aspects of the present disclosure.

FIG. 2 illustrates example operations for predicting future locations of objects in a three-dimensional space using machine learning models, in accordance with aspects of the present disclosure.

FIG. 3 illustrates an example system on which aspects of the present disclosure may be executed, in accordance with aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for predicting object location and/or motion in a multidimensional environment using machine learning models.

Machine learning models may be used in various applications to predict the motion and consequently the future locations of objects in a multidimensional space. These applications include, for example, surveillance applications in which the locations and movement of objects of interest are predicted and tracked, autonomous driving applications in which the future locations and movements of various objects are predicted in order to minimize, or at least reduce, a likelihood of collisions occurring between an autonomous vehicle and these objects, robotics applications in which robotic manipulators (e.g., robotic arms) are used to manipulate or otherwise interact with objects in a multidimensional environment, and the like. Generally, in predicting the future locations and motion of objects in a multidimensional space, machine learning models may be trained to do so as a function of current and past positions of the object. By doing so, predictions of object motion may be constrained, or at least influenced, by how the object has moved in the past so that unlikely patterns of motion or dubious new locations are not output from the machine learning model.

In many cases, objects may be defined as a point cloud in a multidimensional (e.g., Euclidean) space. Based on the point cloud, predictions of motion and future object location may be made relative to the position of various points in the point cloud. However, the use of independent predictions on a per-point basis to predict motion of an object and/or the future location of an object may result in various inaccuracies in these predictions. For example, the object may not move smoothly over time, with some time steps showing larger displacements (e.g., translation and/or rotation) relative to the position of an object at an immediate prior time step and other time steps showing smaller displacements. In another example, because these machine learning models may predict the future location of objects on a per-point basis, different amounts of displacement may be predicted for each point. Thus, an object may be distorted at various times due to changes in the distance between different points representing an object in the multidimensional environment, and consequently, the coherence of an object across time steps may be compromised.

Certain aspects of the present disclosure provide techniques for accurately predicting the location of and future movement of objects in a multidimensional space using machine learning models. As discussed in further detail herein, to predict the future location of and/or future movement of objects in a multidimensional space, a machine learning model can generate a predicted movement for a plurality of tokens in a multidimensional space. Generally, each token may correspond to a portion of an object in the multidimensional space. A predicted movement (e.g., translation and/or rotation) may be translated into an object-wise movement to apply to the points in the multidimensional space associated with the object, and based on this object-wise movement and a defined location of the object in the multidimensional space (e.g., a starting location of the object or a predicted location of the object in a previous time step), the predicted future location of the object may be output. By doing so, certain aspects of the present disclosure may improve the accuracy and fidelity of object motion prediction in multidimensional environments by increasing the smoothness of object motion and minimizing, or at least reducing, changes in object coherence over time.

### Example Object Location Prediction Using Machine Learning Models

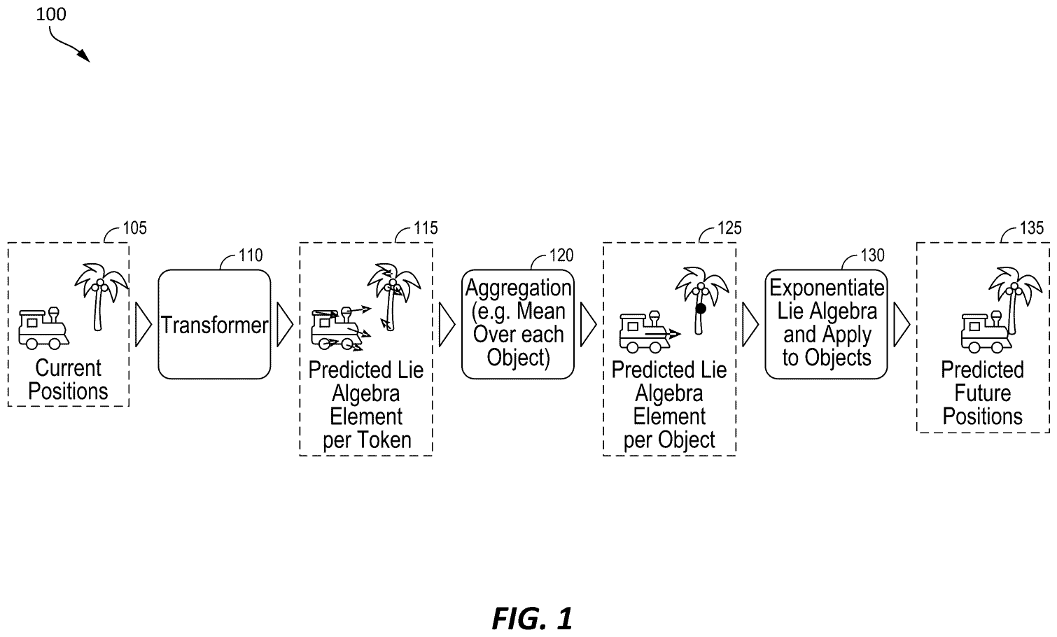

FIG. 1 depicts an example pipeline 100 for predicting future locations of objects in a multidimensional space using a machine learning model, in accordance with aspects of the present disclosure.

As illustrated, the pipeline 100 may begin with the input of a current position 105 for each of one or more objects in a multidimensional environment. As discussed, each object may be defined as a point cloud in the multidimensional space. The point cloud for a specific object in the multidimensional environment may, in some aspects, include a reference point based on which object motion is defined and one or more other points which are modified based on the predictions of object movement at a subsequent time step. These one or more other points may include, for example, points defining a perimeter or surface of an object.

The current position(s) 105 of the one or more objects in the multidimensional environment may be input into a machine learning model 110 for processing. While the machine learning model 110 is labeled as a transformer in FIG. 1, it should be recognized that the machine learning model may be any suitable machine learning model, such as a deep neural network (DNN), a convolutional neural network (CNN), or the like, which can be trained to predict the future positions of objects in a multidimensional space based on the current and past positions of these objects.

The machine learning model 110 is generally trained to generate a predicted per-token movement 115, with each token corresponding to a different point in a point cloud for an object in the multidimensional space. In some aspects, the machine learning model 110 may be a transformer neural network trained based on a ground-truth data set of the coordinates of an object in a multidimensional space at each of a plurality of points in time. The ground-truth data set of object coordinates may be derived, for example, from trajectories of rigid body motion from various data sets in which objects are defined in terms of coordinates in a multidimensional space over time. In training the machine learning model 110, the mean squared error between predicted coordinates and ground-truth coordinates for the points defining an object in the multidimensional space may be minimized.

The predicted movement generated by the machine learning model may, in some aspects, be a Lie algebra element predicted on a per-token basis. The Lie algebra element may be, in some aspects, an element including a plurality of translations and/or a plurality of rotations to apply to a point in the three-dimensional space. The translations may include an amount by which the point is displaced from the same point at a previous time step along any of the horizontal, vertical, or depth axes in the multidimensional space (in aspects in which motion is predicted in a three-dimensional space). The rotations may include an amount by which the point is displaced from the same point at a previous time step along any of a yaw axis, a pitch axis, or a roll axis in the three-dimensional space.

Generally, O(3) may be matrices R∈ [symbol] , that correspond to an orthogonal matrix such that RR^{T} =R^{T}R=I, where I is the identity matrix. The Euclidean group E(3) may consist of rotations and translations of [symbol] . Elements in E(3) preserve distances when acting on [symbol] , with elements represented as the pair (R, t), where t corresponds to a translation vector that transforms a point x∈ [symbol] as x [symbol] Rx+t. Within the Euclidean group E(3), a special Euclidean group SE(3) exists, in which elements are pairs of an orthogonal matrix R∈SO(3) and a translation vector. A translation based on a matrix in the special Euclidean group SE(3) may be represented as a 4×4 matrix as

$$( \begin{matrix}R & t \\ 0 & 1\end{matrix} ) .$$

The action applied to a point p∈ [symbol] using a matrix in SE(3) may be a linear action when a coordinate (x, 1)∈ [symbol] is added, according to the equation:

$$( \begin{matrix}R & t \\ 0 & 1\end{matrix} ) ( \begin{matrix}p \\ 1\end{matrix} ) = ( \begin{matrix}Rp + t \\ 1\end{matrix} )$$

In some aspects, the Lie algebra elements corresponding to a predicted per-point motion of an object may have values indicating a magnitude of the predicted motion of the object. Generally, a value of 0 may correspond to no movement between a first time period and a second time period for a point, while larger values may correspond to larger amounts of movement. In some aspects, translation motion may be unbounded and may be signed such that negative values correspond to backwards movement along an axis while positive values correspond to forward movement along an axis. In some aspects, rotational movement may be bounded between positive and negative 360 degrees, with 0 degree rotation representing no rotational motion along an axis, 360 degree negative motion representing a full rotation in one direction (e.g., clockwise), and 360 degree positive motion representing a full rotation in the opposite direction (e.g., anticlockwise).

To allow for predictions of future object locations that result in perceptually smooth motion and object coherence, the predicted per-token movement 115 may be aggregated at the aggregation block 120 so that an object is treated as a rigid object where the same rotation and/or translation (e.g., the same rototranslation) is applied to each point (corresponding to a token in the machine learning model 110) associated with an object. Generally, the aggregation block 120 can aggregate the predicted movement of each point associated with an object into an aggregated movement and calculate a mean movement over the object based on the aggregated movement and the number of points associated with the object. This mean movement may be output as the predicted object-wise movement 125.

An exponentiator 130 uses the predicted object-wise movement 125 to predict the future position(s) 135 of object(s) in the multidimensional space. The exponentiator 130 generally accounts for the fact that the space of matrices in SO(3) is a curved manifold instead of a vector space. For rotations in SO(3) that are close to the identity, the predicted object-wise movement may be parameterized based on a unit vector n∈ [symbol] and an angle ϕ∈ [symbol] , which encodes a rotation by angle ϕ around the unit vector n. Because (n, ϕ) and (−n, −ϕ) encode the same rotation, the Lie algebra x for a point of an object may be defined according to the expression x=ϕn∈ [symbol] . The direction of x may be the axis, and the norm of x may be the angle. As such, the space of axis-angles may define a Lie algebra of the group SO(3) as [symbol] (3)= [symbol] .

A point in the Lie algebra [symbol] (3) may be expressed as the matrix M with dimensions D×D:

$$\overline{x} = ( \begin{matrix}0 & - {x}_{3} & {x}_{2} \\ {x}_{3} & 0 & - {x}_{1} \\ - {x}_{2} & {x}_{1} & 0\end{matrix} )$$

The matrix exponential, mexp: [symbol] 43 [symbol] may be defined according to the equation:

$$m exp ( M ) = I + M + \frac{1}{2} {M}^{2} + \frac{1}{6} {M}^{3} + … = {\sum }_{n = 0}^{∞} \frac{1}{n !} {M}^{n}$$

where Mⁿ denotes the matrix multiplication of n copies of M.

The rotation R∈SO(3) corresponding to the axis-angle x∈ [symbol] (3) may be computed by the exponentiator based on the matrix exponential, which maps [symbol] (3) to SO(3) according to the expression: exp_{SO(3)}(x)=mexp (x̅). Because the mapping of [symbol] (3) to SO(3) involves an infinite sum, the mapping can be reduced to the finite expression:

$${exp}_{SO ( 3 )} ( x ) = I + \frac{sin ‖ x ‖}{‖ x ‖} + \frac{1 - cos ‖ x ‖}{‖ x ‖} {\overline{x}}^{2}$$

For rotations and translations in SE(3), the exponentiator 130 can generate the translation matrices and rotation matrices in a similar manner to rotations in SO(3). The axis-angle parameterization x∈SO(3) described above may be combined with a translation y∈ [symbol] , forming the pair z=(x, y)∈ [symbol] representing the Lie algebra [symbol] (3) of the group SE(3), which may be located in a six-dimensional vector space [symbol] corresponding to three translational dimensions and three rotational dimensions. The matrix representation of z=(x, y)∈ [symbol] (3) may be expressed as the matrix:

$$\overline{z} = ( \begin{matrix}0 & - {x}_{3} & {x}_{2} & {y}_{1} \\ {x}_{3} & 0 & - {x}_{1} & {y}_{2} \\ - {x}_{2} & {x}_{1} & 0 & {y}_{3} \\ 0 & 0 & 0 & 0\end{matrix} )$$

An exponential mapping [symbol] (3)→SE(3) may be performed according to the expression: exp_{SE(3)}(z)=mexp(z̅), which may be reduced to the closed-form expression:

$${exp}_{s e ( 3 )} ( ( x , y ) ) = ( \begin{matrix}R & \frac{1}{{‖ x ‖}^{2}} ( I - R ) \overline{x} y + hy \\ 0 & 1\end{matrix} )$$

$$where$$

$$R = {exp}_{S O ( 3 )} ( x ) and h = {x}^{t} y / ‖ x ‖$$

In some aspects, the exponentiator 130 can generate translation matrices and rotation matrices based on matrix exponentials and geographic algebra, respectively, to determine how an object moves in the multidimensional space. Generally, in predicting the future location(s) of object(s) in the multidimensional space, the predicted object-wise movement 125, which may be an average translation and rotation (e.g., in [symbol] (3)) to apply to each point in the multidimensional space associated with an object, may be added to the current position 105 of the object. In some aspects, the exponentiator 130 can transform the predicted object-wise movement 125 into (R,t)∈SE(3) based on the exponentiation techniques discussed above, such that the location of any point p (associated with an object being updated) is updated according to

$$( \begin{matrix}R & t \\ 0 & 1\end{matrix} ) ( \begin{matrix}p \\ 1\end{matrix} ) = ( \begin{matrix}Rp + t \\ 1\end{matrix} ) ,$$

as discussed above. By doing so, the predicted future position of the object may be generated such that the movement of the object is represented as a movement of each point of the plurality of points defining the object relative to a defined reference point. The defined reference point may be, for example, the geometric center of the object, a balancing point (e.g., center of gravity point, relative to the object or a portion of the object, such as percent mean aerodynamic chord where the object is an airplane or other flying object) defined for the object, an external point relative to which an object is moving (e.g., a reference plane associated with an imaging or ranging device based on which the current position(s) 105 of object(s) in the three-dimensional space are identified, or the like).

### Example Operations for Object Location Prediction Using Machine Learning Models

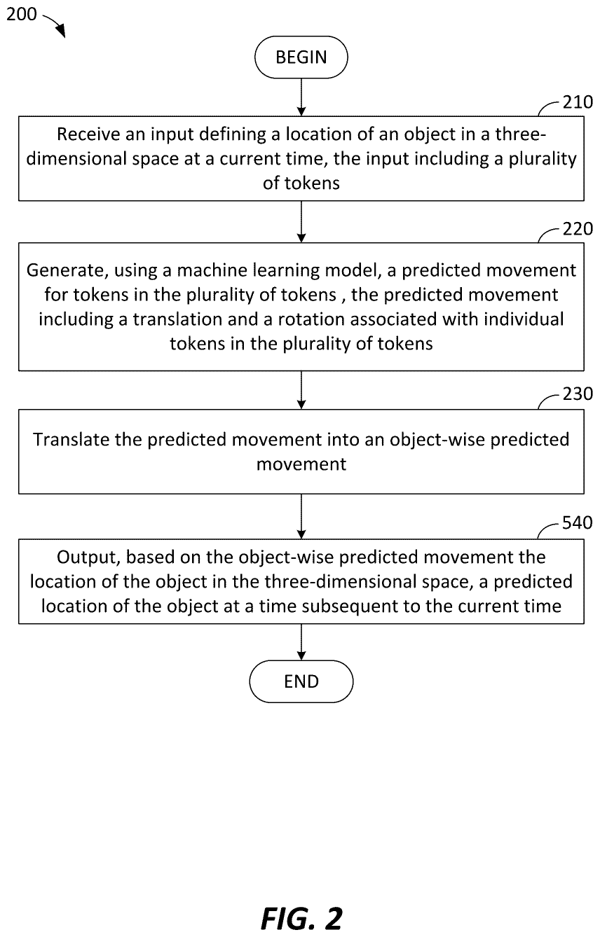

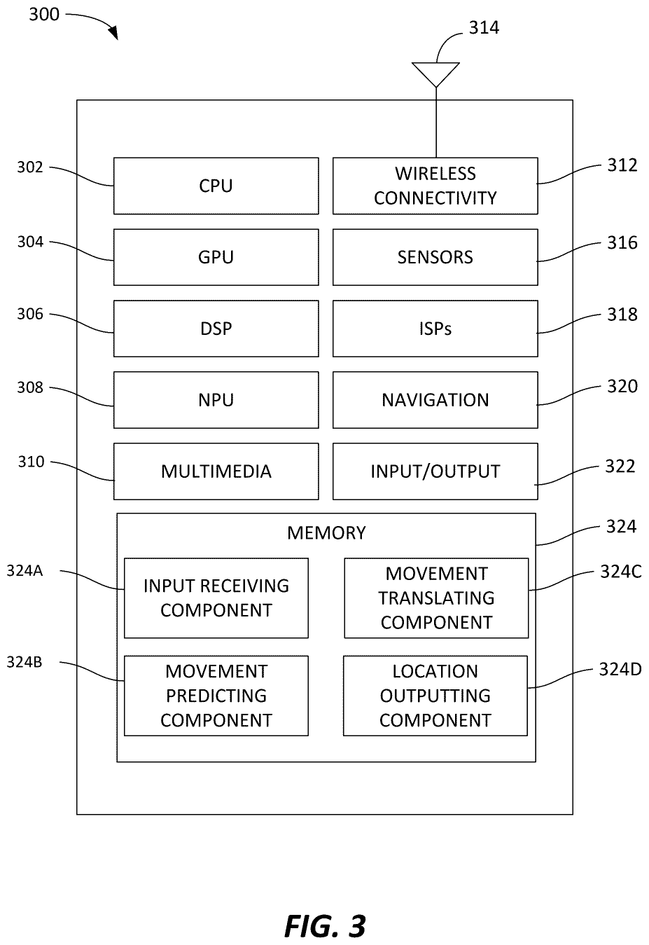

FIG. 2 shows an example of operations 200 for predicting future locations of objects in a three-dimensional space using machine learning models, in accordance with aspects of the present disclosure. In some examples, the operations 200 may be performed by a device, such as an example processing system 300 illustrated in FIG. 3 implementing the pipeline 100 illustrated in FIG. 1.

As illustrated, the operations 200 begin at block 210, with receiving an input defining a location of an object in a three-dimensional space at a first time. Generally, the input includes a plurality of tokens. Each token may, in some aspects, represent a point associated with the object. The point may be, for example, a defined reference point for the object (e.g., a center of the object, a center of gravity defined for the object, etc.), a point on a surface of the object, or the like. In some aspects, the point may be defined as a coordinate in a Euclidean space. In other aspects, the point may be defined with polar coordinates.

At block 220, the operations 200 proceed with generating, using a transformer neural network, a predicted movement for tokens in the plurality of tokens, the predicted movement including a translation and a rotation associated with individual tokens in the plurality of tokens.

In some aspects, the predicted movement for the plurality of tokens comprises a predicted Lie algebra element for each token of the plurality of tokens. The Lie algebra element may include, in some aspects, a plurality of translational elements and a plurality of rotational elements. Values of the Lie algebra elements may include a magnitude and direction of the motion of a point within a multidimensional space. Generally, values of 0 may indicate that a point is stationary between the first time and a second time. In some aspects, signed values may indicate a direction of motion. For example, negative translational values may indicate backwards or downwards motion, while positive translational motion may indicate forward or upward motion (or vice versa). In another example, negative rotational values may indicate rotation in a clockwise direction, while positive rotational values may indicate rotation in an anticlockwise direction (or vice versa).

In some aspects, the translation comprises a per-token movement in the three-dimensional space along any of a horizontal axis, a vertical axis, or a depth axis.

In some aspects, the rotation comprises a per-token rotation in the three-dimensional space along any of a yaw axis, a pitch axis, or a roll axis.

At block 230, the operations 200 proceed with translating the predicted movement into an object-wise predicted movement.

In some aspects, translating the predicted movement into the object-wise predicted movement comprises aggregating the predicted movement for the plurality of tokens based on a mean of values of the plurality of tokens.

In some aspects, translating the predicted movement into the object-wise predicted movement further comprises generating the predicted location of the object at the second time subsequent to the first time based on exponentiating the aggregated predicted movement for the plurality of tokens.

In some aspects, the object-wise predicted movement comprises a movement for one or more tokens associated with the object relative to a defined reference point for the object. The defined reference point may be a reference point inside the object, such as a mass-independent center point of the object or the center of gravity of the object.

At block 240, the operations 200 proceed with outputting, based on the object-wise predicted movement and the location of the object in the three-dimensional space, a predicted location of the object at a second time subsequent to the first time.

### Example Processing Systems for Object Location Prediction Using Machine Learning Models

FIG. 3 depicts an example processing system 300 for predicting the location and movement of an object in a multidimensional space using a machine learning model, such as described herein for example with respect to FIGS. 1-2.

The processing system 300 includes a central processing unit (CPU) 302, which in some examples may be a multi-core CPU. Instructions executed at the CPU 302 may be loaded, for example, from a program memory associated with the CPU 302 or may be loaded from a memory 324.

The processing system 300 also includes additional processing components tailored to specific functions, such as a graphics processing unit (GPU) 304, a digital signal processor (DSP) 306, a neural processing unit (NPU) 308, a multimedia processing unit 310, and a wireless connectivity component 312.

An NPU, such as the NPU 308, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 308, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the plurality of NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 308 is a part of one or more of the CPU 302, the GPU 304, and/or the DSP 306.

In some examples, the wireless connectivity component 312 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and other wireless data transmission standards. The wireless connectivity component 312 is further coupled to one or more antennas 314.

The processing system 300 may also include one or more input and/or output devices 322, such as screens, touch-sensitive surfaces (including touch-sensitive displays), physical buttons, speakers, microphones, and the like.

In some examples, one or more of the processors of the processing system 300 may be based on an ARM or RISC-V instruction set.

The processing system 300 also includes the memory 324, which is representative of one or more static and/or dynamic memories, such as a dynamic random access memory, a flash-based static memory, and the like. In this example, the memory 324 includes computer-executable components, which may be executed by one or more of the aforementioned processors of the processing system 300.

In particular, in this example, the memory 324 includes an input receiving component 324A, a movement predicting component 324B, a movement translating component 324C, and a location outputting component 324D. The depicted components, and others not depicted, may be configured to perform various aspects of the methods described herein.

Generally, the processing system 300 and/or components thereof may be configured to perform the methods described herein.

Notably, in other aspects, elements of the processing system 300 may be omitted, such as where the processing system 300 is a server computer or the like. Further, elements of the processing system 300 may be distributed, such as training a model and using the model to generate inferences, such as user verification predictions.

### Example Clauses

Implementation details of various aspects of the present disclosure are described in the following numbered clauses.
Clause 1: A processor-implemented method for machine learning, comprising: receiving an input defining a location of an object in a three-dimensional space at a first time, the input including a plurality of tokens; generating, using a transformer neural network, a predicted movement for tokens in the plurality of tokens, the predicted movement including a translation and a rotation associated with individual tokens in the plurality of tokens; translating the predicted movement into an object-wise predicted movement; and outputting, based on the object-wise predicted movement and the location of the object in the three-dimensional space, a predicted location of the object at a second time subsequent to the first time.
Clause 2: The method of Clause 1, wherein the predicted movement for the plurality of tokens comprises a predicted Lie algebra element for each token of the plurality of tokens.
Clause 3: The method of Clause 1 or 2, wherein translating the predicted movement into the object-wise predicted movement comprises aggregating the predicted movement for the plurality of tokens based on a mean of values of the plurality of tokens.
Clause 4: The method of Clause 3, wherein translating the predicted movement into the object-wise predicted movement further comprises generating the predicted location of the object at the second time subsequent to the first time based on exponentiating the aggregated predicted movement for the plurality of tokens.
Clause 5: The method of any of Clauses 1 through 4, wherein the object-wise predicted movement comprises a movement for one or more tokens associated with the object relative to a defined reference point for the object.
Clause 6: The method of any of Clauses 1 through 5, wherein the translation comprises a per-token movement in the three-dimensional space along any of a horizontal axis, a vertical axis, or a depth axis.
Clause 7: The method of any of Clauses 1 through 6, wherein the rotation comprises a per-token rotation in the three-dimensional space along any of a yaw axis, a pitch axis, or a roll axis.
Clause 8: A processing system comprising: a memory comprising computer-executable instructions; and one or more processors configured to execute the computer-executable instructions and cause the processing system to perform a method in accordance with any of Clauses 1 through 7.
Clause 9: A processing system comprising means for performing a method in accordance with any of Clauses 1 through 7.
Clause 10: A non-transitory computer-readable medium comprising computer-executable instructions that, when executed by one or more processors of a processing system, cause the processing system to perform a method in accordance with any of Clauses 1 through 7.
Clause 11: A computer program product embodied on a computer-readable storage medium comprising code for performing a method in accordance with any of Clauses 1 through 7.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning, comprising:
at least one memory having executable instructions stored thereon; and
one or more processors configured to execute the executable instructions to cause the processing system to:
receive an input defining a location of an object in a three-dimensional space at a first time, the input including a plurality of tokens;
generate, using a transformer neural network, a predicted movement for tokens in the plurality of tokens, the predicted movement including a translation and a rotation associated with individual tokens in the plurality of tokens;
translate the predicted movement into an object-wise predicted movement; and
output, based on the object-wise predicted movement and the location of the object in the three-dimensional space, a predicted location of the object at a second time subsequent to the first time.

2. The processing system of claim 1, wherein the predicted movement for the plurality of tokens comprises a predicted Lie algebra element for each token of the plurality of tokens.

3. The processing system of claim 1, wherein to translate the predicted movement into the object-wise predicted movement, the one or more processors are configured to cause the processing system to aggregate the predicted movement for the plurality of tokens based on a mean of values of the plurality of tokens.

4. The processing system of claim 3, wherein to translate the predicted movement into the object-wise predicted movement, the one or more processors are configured to cause the processing system to generate the predicted location of the object at the second time subsequent to the first time based on exponentiation of the aggregated predicted movement for the plurality of tokens.

5. The processing system of claim 1, wherein the object-wise predicted movement comprises a movement for one or more tokens associated with the object relative to a defined reference point for the object.

6. The processing system of claim 1, wherein the translation comprises a per-token movement in the three-dimensional space along any of a horizontal axis, a vertical axis, or a depth axis.

7. The processing system of claim 1, wherein the rotation comprises a per-token rotation in the three-dimensional space along any of a yaw axis, a pitch axis, or a roll axis.

8. A processor-implemented method for machine learning, comprising:
receiving an input defining a location of an object in a three-dimensional space at a first time, the input including a plurality of tokens;
generating, using a transformer neural network, a predicted movement for tokens in the plurality of tokens, the predicted movement including a translation and a rotation associated with individual tokens in the plurality of tokens;
translating the predicted movement into an object-wise predicted movement; and
outputting, based on the object-wise predicted movement and the location of the object in the three-dimensional space, a predicted location of the object at a second time subsequent to the first time.

9. The method of claim 8, wherein the predicted movement for the plurality of tokens comprises a predicted Lie algebra element for each token of the plurality of tokens.

10. The method of claim 8, wherein translating the predicted movement into the object-wise predicted movement comprises aggregating the predicted movement for the plurality of tokens based on a mean of values of the plurality of tokens.

11. The method of claim 10, wherein translating the predicted movement into the object-wise predicted movement further comprises generating the predicted location of the object at the second time subsequent to the first time based on exponentiating the aggregated predicted movement for the plurality of tokens.

12. The method of claim 8, wherein the object-wise predicted movement comprises a movement for one or more tokens associated with the object relative to a defined reference point for the object.

13. The method of claim 8, wherein the translation comprises a per-token movement in the three-dimensional space along any of a horizontal axis, a vertical axis, or a depth axis.

14. The method of claim 8, wherein the rotation comprises a per-token rotation in the three-dimensional space along any of a yaw axis, a pitch axis, or a roll axis.

15. A processing system for machine learning, comprising:
means for receiving an input defining a location of an object in a three-dimensional space at a first time, the input including a plurality of tokens;
means for generating, using a transformer neural network, a predicted movement for tokens in the plurality of tokens, the predicted movement including a translation and a rotation associated with individual tokens in the plurality of tokens;
means for translating the predicted movement into an object-wise predicted movement; and
means for outputting, based on the object-wise predicted movement and the location of the object in the three-dimensional space, a predicted location of the object at a second time subsequent to the first time.

16. The processing system of claim 15, wherein the predicted movement for the plurality of tokens comprises a predicted Lie algebra element for each token of the plurality of tokens.

17. The processing system of claim 15, wherein the means for translating comprises means for aggregating the predicted movement for the plurality of tokens based on a mean of values of the plurality of tokens.

18. The processing system of claim 17, wherein the means for translating further comprise means for generating the predicted location of the object at the second time subsequent to the first time based on exponentiating the aggregated predicted movement for the plurality of tokens.

19. The processing system of claim 15, wherein the object-wise predicted movement comprises a movement for one or more tokens associated with the object relative to a defined reference point for the object.

20. The processing system of claim 15, wherein at least one of:
the translation comprises a per-token movement in the three-dimensional space along any of a horizontal axis, a vertical axis, or a depth axis; or
the rotation comprises a per-token rotation in the three-dimensional space along any of a yaw axis, a pitch axis, or a roll axis.
